(19) United States
(12) Patent Application Publication
(10) Pub. No.: US 2017/0277411 A1
(43) Pub. Date: Sep. 28, 2017

(54) DISPLAY CONTROL DEVICE, ELECTRONIC DEVICE, NON-TRANSITORY COMPUTER READABLE MEDIUM AND DISPLAY CONTROL METHOD

(71) Applicant: FUJI XEROX CO., LTD., Tokyo (JP)

(72) Inventors: Kiyoshi YASUKAWA, Yokohama-shi (JP); Nozomi NOGUCHI, Yokohama-shi (JP); Shinichi NAKAMURA, Yokohama-shi (JP); Ayaka ISHIHARA, Yokohama-shi (JP)

(73) Assignee: FUJI XEROX CO., LTD., Tokyo (JP)

(21) Appl. No.: 15/220,198

(22) Filed: Jul. 26, 2016

(30) Foreign Application Priority Data
Mar. 22, 2016 (JP) 2016-056861

(51) Int. Cl. G06F 3/0484; G06K 15/00; G06F 3/0488; G06F 3/0482; G06T 13/80

(52) U.S. Cl. CPC G06F 3/04845; G06F 3/0482; G06T 13/80; G06F 3/04883; G06K 15/005

(57) ABSTRACT

There is provided a display control device. A display control unit displays a first operation image operated by a user when a state notification screen for notifying the user of a state of a process is not displayed and a second operation image operated by the user when the process is stopped, and displays movement when the state notification screen transits from a display to a non-display in a case where the first operation image is operated.

### CROSS-REFERENCE TO RELATED APPLICATIONS

This application is based on and claims priority under 35 U.S.C. §119 from Japanese Patent Application No. 2016-056861 filed on Mar. 22, 2016.

### TECHNICAL FIELD

A present invention relates to a display control device, an electronic device, a non-transitory computer readable medium and a display control method.

### SUMMARY

According to an aspect of the embodiments of the present invention, there is provided a display control device comprising a display control unit that displays a first operation image operated by a user when a state notification screen for notifying the user of a state of a process is not displayed and a second operation image operated by the user when the process is stopped, and displays movement when the state notification screen transits from a display to a non-display in a case where the first operation image is operated.

### BRIEF DESCRIPTION OF THE DRAWINGS

Exemplary embodiments of the present invention will be described in detailed based on the following figures, wherein:

FIG. 1 is a drawing showing a hardware configuration of an image forming apparatus;

FIG. 2 is a drawing showing an example of a screen transition;

FIG. 3 is a drawing showing another example of the screen transition;

FIG. 4 is a drawing showing still another example of the screen transition; and

FIG. 5 is a drawing showing still another example of the screen transition.

### DETAILED DESCRIPTION

An example of an exemplary embodiment of the invention will be described.

<Configuration>

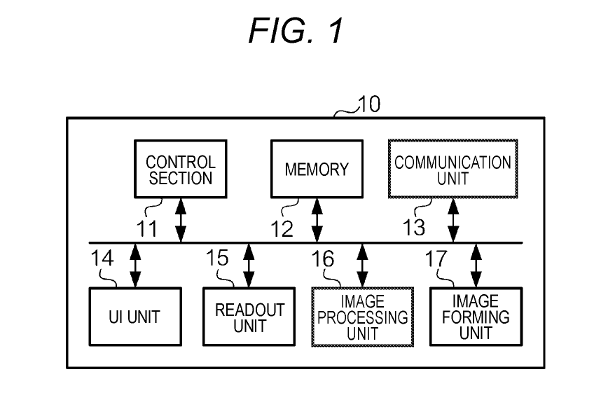

FIG. 1 is a drawing showing a hardware configuration of an image forming apparatus 1. The image forming apparatus 1 is an example of an information processing device according to the exemplary embodiment of the invention. The image forming apparatus 1 is provided with a control section 11, a memory 12, a communication unit 13, a user interface (UI) unit 14, a readout unit 15, an image processing unit 16, and an image forming unit 17.

The control section 11 is provided with a calculation device such as a central process unit (CPU), and a storage device such as a read only memory (ROM) or a random access memory (RAM), and functions as a display control unit that performs display control as described below. The ROM stores firmware in which a starting procedure of hardware or an operating system (OS) is described. The RAM is used for storage of data when the CPU performs calculation. The memory 12 is provided with, for example, a semiconductor memory or a hard disk storage device or the like and stores an application program for realizing various functions, in addition to an OS. The communication unit 13 is provided with a communication interface (I/F) for performing communication with an external electronic device. The communication unit 13 is connected to a communication line such as a local area network (LAN).

A UI unit 14 includes a display and an operation unit. The display is provided with, for example, a liquid crystal display device, and displays a screen on a display surface so that a user operates the image forming apparatus 1. The operation unit 15 is provided with, for example, a touch panel provided so as to cover the display surface of the display 14 or a keyboard provided at a position adjacent to the display surface or the like, receives an operation performed by the user, and outputs a signal in accordance with the operation to the control section 11. The control section 11 controls the image forming apparatus 1 in accordance with the contents of the operation.

The readout unit 15 generates image data by optically reading out an original document. The readout unit 15 is, for example, an image scanner provided with platen glass, a light source, an optical system, a color filter and an image pickup device or the like, in which the light source emits light with respect to the loaded original document on the platen glass, and reflected light reflected by the original document is incident on the image pickup device via the optical system and the color filter. The image pickup device converts the incident light into an image signal and outputs the signal to the image processing unit 16. The image processing unit 16 performs an image process such as a screen process or color conversion on the image signal output from the readout unit 15, and generates raster data. The image forming unit 17 forms an image on a sheet that is a recording medium based on the raster data that the image processing unit 16 generates. An image-forming method is, for example, an electrophotographic method or an ink jet method or the like.

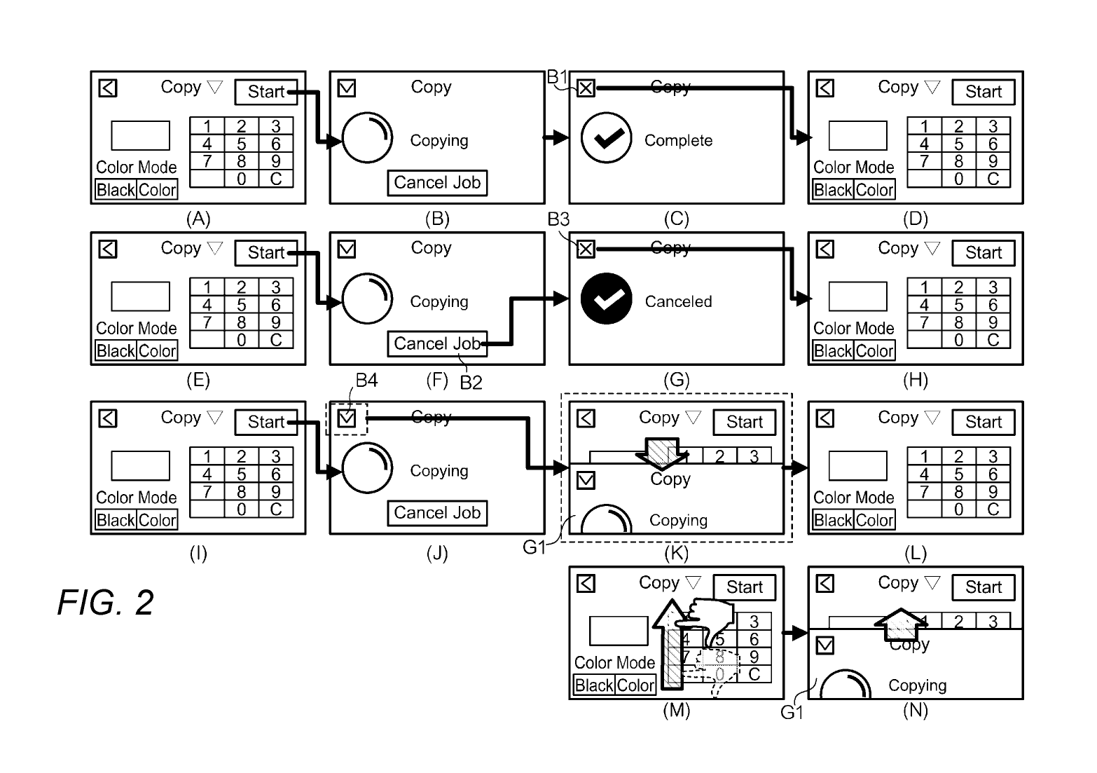

FIG. 2 is a drawing showing a screen transition shown in the UI unit 14. For example, a copy application program is an application program for realizing a copy function for copying the original document. If a start button of the copy application program on a home screen is operated, the control section 11 displays a copy setting screen, as shown in (A) of FIG. 2. The copy setting screen is the screen for operating the copy function, specifically, the screen for setting a condition of the original document readout or a condition of image printing or the like.

Here, although the copy function is performed if a start button in (A) of FIG. 2 is operated, the control section 11 displays a process executing screen as shown in (B) of FIG. 2 during the operation thereof. The process executing screen is one of a state notification screen for notifying the user of a state of a process in the image forming apparatus 1. If the process relating to the copy is completed, the control section 11 displays a process completion screen as shown in (C) of FIG. 2. If a non-display button B1 included in the process completion screen is operated by the user, the control section 11 does not display the process completion screen and returns to the copy setting screen ((D) of FIG. 2).

If the copy function is performed ((E) of FIG. 2) by the start button being operated in the copy setting screen, and a cancel button B2 for stopping the process is operated by the user ((F) of FIG. 2) at the stage where the process executing screen is displayed, the control section 11 displays a process stop screen as shown in (G) of FIG. 2. If a non-display button B3 included in the process stop screen is operated by the user, the control section 11 does not display the process stop screen, and returns to the copy setting screen ((H) of FIG. 2).

If the copy function is performed ((I) of FIG. 2) by the start button being operated in the copy setting screen, and a button B4 for not displaying the process executing screen is operated by the user ((J) of FIG. 2) at the stage where the process executing screen is displayed, the control section 11, as shown in (K) of FIG. 2, performs an animation display so that the process executing screen G1 moves to a lower side (front side as viewed from the user) and goes out to the outside of a display area of the UI unit 14. In this manner, the control section 11 does not display the process executing screen G1 and returns to the copy setting screen ((L) of FIG. 2). That is, the animation display is equivalent to displaying the movement when the process executing screen transits from a display to a non-display.

If the user operates the operation that is a reverse movement of the movement of the animation display, that is, a so-called flick operation ((M) of FIG. 2) of moving a finger from the lower side (front side as viewed from the user) of the display area of the UI unit 14 to an upper side (direction away where viewed from the user) in the copy setting screen, the control section 11, as shown in (N) of FIG. 2, performs the animation display so that the process executing screen which is a non-display moves to the upper side from the outside of the display area of the lower side of the UI unit 14. In this manner, the control section 11 causes the process executing screen G1 to be displayed again. This movement is referred to as a re-display operation. The re-display operation is equivalent to the operation in accordance with the movement when the process executing screen transits from the display to the non-display.

Although the above-described button B1 and the button B4 are both an operator image for not displaying the screen, a design thereof and an operated behavior are different from each other. That is, the button B1 is the design called “x”, and while the animation display is not performed in accordance with the movement of the process completion screen when the screen is transited from the display to the non-display, the button B4 is the design that imitates the downward arrow, and the animation display is performed in accordance with the movement of the process executing screen when the screen is transited from the display to the non-display. The operator image of the design with “x” is generally used to mean the stopping of a process or a screen deletion in some cases. Therefore, if the button B4 adopts this design, it is unlikely to inform the user that the re-display of the process executing screen is possible. The button B4 adopts the design that imitates the downward arrow indicating a movement direction when the process executing screen is the non-display, and represents the movement of the process executing screen in the operation. Therefore, a re-display method of the process executing screen is suggested to the user.

Although FIG. 2 is an example of the copy function, the function that the image forming apparatus 1 realizes, in addition to the copy function, for example, is a scan function or a facsimile function or the like, and a process in which each of the plural functions are different is performed. In a case where the above-described re-display operation is performed in a setting screen relating to any one function among the plural functions, the control section 11 displays the state notification screen for notifying of the state of the process in the function. That is, in a case where the above-described re-display operation is performed in the copy setting screen, the control section 11 displays the state notification screen in the copy function. In a case where the above-described re-display operation is performed in the scan setting screen, the control section 11 displays the state notification screen in the scan function. In a case where the user wishes to display the state notification screen again after the state notification screen is not displayed, it is natural to start the function in accordance with the state notification screen. Therefore, in a case where the re-display operation is performed in the setting screen of the corresponding function as described above, it may be said that it is intuitively and easily imagined for the user to display the state notification screen.

Here, for example, in the process of executing a certain function, there is a case where any error occurs. At this time, the control section 11 displays an error notification screen for notifying that the process is in an error state. The error notification screen is one of the state notification screens for notifying the user of the state of the process in the image forming apparatus 1. Accordingly, even for the error notification screen, as well as the process executing screen, it is possible not to display the screen by the button operation for the non-display or to display the screen again in accordance with the re-display operation.

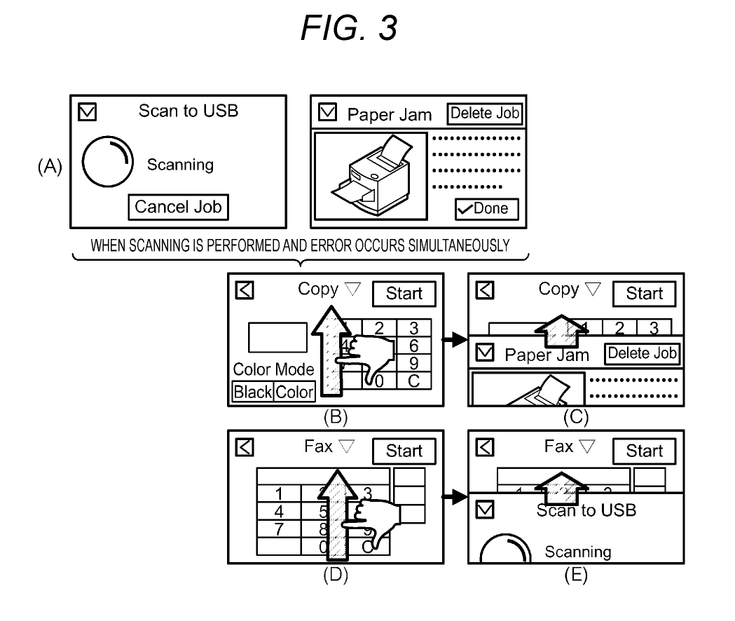

FIG. 3 is a drawing showing a screen transition in a case where the error such as a paper jam occurs when the function of storing readout data of the original document (scan to USB) in the storage medium connected by a USB to the image forming apparatus 1 and the above-described copy function are simultaneously realized. A left side screen of (A) of FIG. 3 is the process executing screen in this case, and a right side screen of (B) of FIG. 3 is the error notification screen in this case. Here, the copy setting screen is set to be displayed as described in (B) of FIG. 3. In a case where the different function are simultaneously realized in this manner and the same resource in these functions (image forming unit 17) is used, if the re-display operation is performed, priority is given to the re-display of the error notification screen. In this manner, in a case where the process different in each of the plural functions is performed and the re-display operation in the screen relating to a first function is performed, the state notification screen for notifying of the state of the process in a second function that uses the resource used in the first function is displayed.

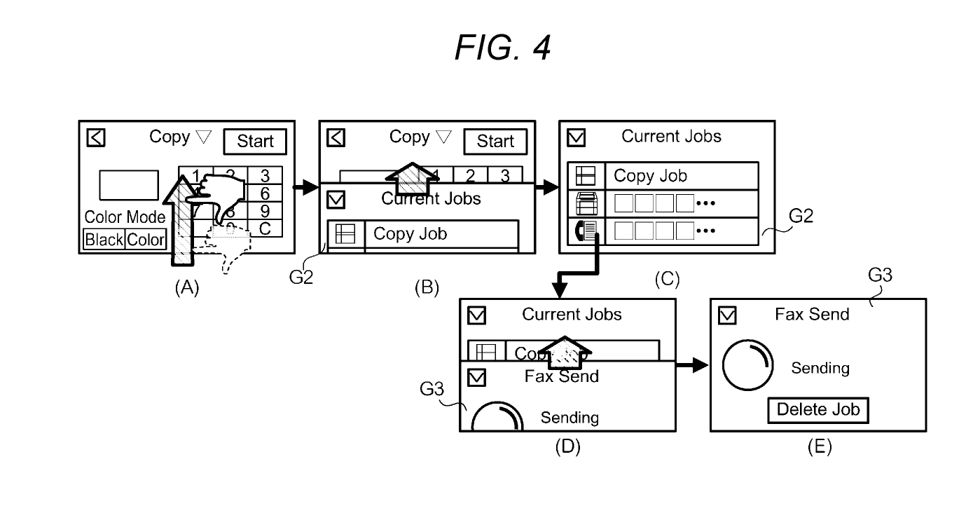

Additionally, in a case where the plural functions are operated in parallel or in a case where any one of the plural functions is on standby for the process, if the re-display operation is performed ((A) of FIG. 4), the control section 11 is displayed with an animation so that a function list screen G2 moves to the upper side from the outside of the display area of the lower side of the UI unit 14. If the function that the user wishes to display is selected ((C) of FIG. 4), the control section 11 is displayed with the animation so that a state notification screen G3 relating to the selected function moves to the upper side from the outside of the display area of the lower side of the UI unit 14 ((D) and (E) of FIG. 4).

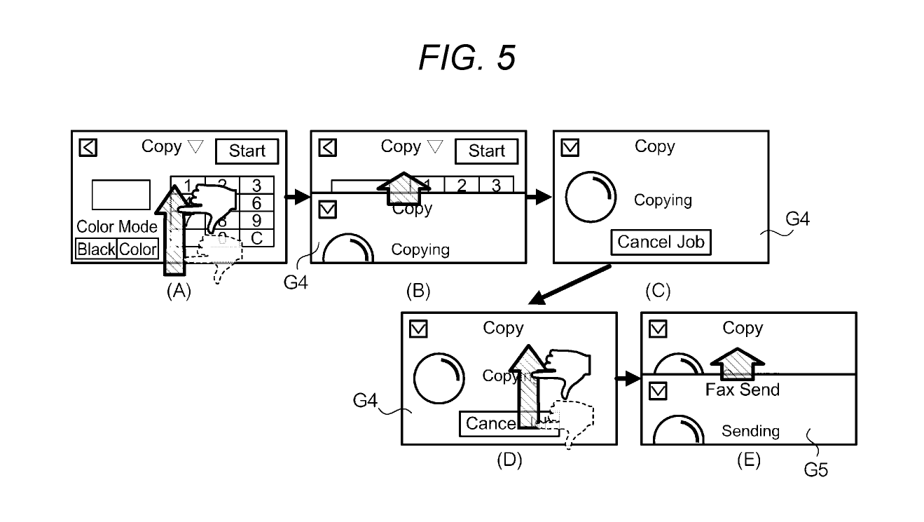

Each time the re-display operation is performed, the control section 11 may display the state notification screen in a predetermined order. That is, as shown in (A) to (E) of FIG. 5, the control section 11 displays a state notification screen G4 relating to the first function again at the first re-display operation ((A) to (C) of FIG. 4), and displays a state notification screen G5 relating to the second function again at the second re-display operation ((D) and (E) FIG. 4). As a variation in the predetermined order, it is conceivable to adopt the method of displaying in the order from those in which the start of the process is late (display from those of which the start of the process is most recently instructed), displaying in the order from those in which the start of the process is early, displaying in the order in which the image forming apparatus 1 starts the process, displaying from the state notification screen related to the function of the setting screen which is already displayed, and displaying the state notification screen of the function which uses the same resource as the function of the setting screen already displayed.

Furthermore, after the state notification screen is not displayed, if the setting screen of the function is not displayed and transited to the other screen, the user no longer understand the re-display method of the state notification screen. Then, the control section 11 may display the state notification screen that is not displayed again at the timing of starting the related function.

The process completion screen may be displayed again in accordance with the re-display operation. In this case, the display of the process completion screen may be limited to only once. That is, the process completion screen that is displayed once may not be displayed again.

According to the exemplary embodiment, the button B4 which instructs the state notification screen not to be displayed, adopts the design that imitates the downward arrow that refers to the direction of the movement when the process executing screen is not displayed, and represents the non-display of the movement of the state notification screen at the time of operation of this button. In this manner, the re-display method of the state notification screen may be suggested to the user.

Furthermore, the state notification screen may not be displayed on the entire display area of the UI unit 14, and may be held to the display of a portion of the display area only. In the above-described exemplary embodiment, although the example of the operation unit having the function of the touch panel is described, the operation unit may include a pointing device such as a mouse.

In the above-described exemplary embodiment, although the example of realizing the above function by the control section 11 executing the program is described, the above function may be mounted in a hardware circuit. The program is stored and provided in a computer readable recording medium such as an optical recording medium, a semiconductor memory or the like, and may be installed in the information processing device by reading out the program from the recording medium. This program may be provided in an electrical communication line.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display control device comprising a display control unit that displays a first operation image operated by a user when a state notification screen for notifying the user of a state of a process is not displayed and a second operation image operated by the user when the process is stopped, and displays movement when the state notification screen transits from a display to a non-display in a case where the first operation image is operated.

2. The display control device according to claim 1, wherein in a case where a re-display operation is performed which is a operation in accordance with the movement when the state notification screen transits from the display to the non-display, the display control unit displays again the state notification screen that is not displayed.

3. The display control device according to claim 2,
wherein the process different in each of a plurality of functions is performed, and
wherein in a case where the re-display operation in a screen relating to any one function among the plurality of functions is performed, the display control unit displays the state notification screen for notifying of the state of the process in the function.

4. The display control device according to claim 2,
wherein the process different in each of the plurality of functions is performed, and
wherein in a case where the re-display operation in the screen relating to a first function is performed, the display control unit displays the state notification screen for notifying of the state of the process in a second function that uses a resource used in the first function.

5. The display control device according to claim 2,
wherein the process different in each of the plurality of functions is performed, and
wherein the display control unit sequentially displays the state notification screen for notifying of the state of the process in the different function, each time the re-display operation is performed.

6. The display control device according to claim 2,
wherein the process different in each of the plurality of functions is performed, and
wherein if the re-display operation is performed, the display control unit displays a list of the state notification screen for notifying of the state of the process in the plurality of functions and displays the state notification screen of the function selected by the user in the list.

7. The display control device according to claim 2, wherein the state notification screen is the screen for notifying that the process is being performed or the screen for notifying that an abnormality occurs in the process.

8. The display control device according to claim 2, wherein in a case where the re-display operation is performed after the process is completed, the display control unit displays a completion notification screen for notifying that the process is completed.

9. The display control device according to claim 8, wherein the display control unit causes the completion notification screen to display a third operation image different from the first operation image operated when the completion notification screen is not displayed, and not to display the completion notification screen, without displaying the movement when the completion notification screen transits from the display to the non-display in a case where the third operating image is operated.

10. The display control device according to claim 1,
wherein the process different in each of the plurality of functions is performed, and
wherein when the screen relating to any one function among the plurality of functions is displayed, the display control unit displays the state notification screen for notifying of the state of the process in the function.

11. The display control device according to claim 9, wherein when the screen relating to any one function among the plurality of functions is displayed, the display control unit partially displays the state notification screen.

12. An electronic device comprising:
a display control device according to claim 1; and
a processing device that performs the process.

13. A non-transitory computer readable medium storing a program causing a computer to function as a display control unit that displays a first operation image operated by a user when a state notification screen for notifying the user of a state of a process is not displayed and a second operation image operated by the user when a process is stopped, and displays movement when the state notification screen transits from a display to a non-display in a case where the first operation image is operated.

14. A display control method comprising displaying a first operation image operated by a user when a state notification screen for notifying the user of a state of a process is not displayed and a second operation image operated by the user when the process is stopped, and displaying movement when the state notification screen transits from a display to a non-display in a case where the first operation image is operated.
